(19) United States
(12) Patent Application Publication
(10) Pub. No.: US 2005/0037876 A1
(43) Pub. Date: Feb. 17, 2005

(54) Continuously variable transmission and method of controlling it

(76) Inventors: Toshio Unno, Iwata-shi (JP); Haruyoshi Hino, Iwata-shi (JP); Mitsukazu Takebe, Iwata-shi (JP)

Correspondence Address: Keating & Bennett, Suite 312, 10400 Eaton Place, Fairfax, VA, 22030, US

(21) Appl. No.: 10/497,489

(22) PCT Filed: Dec. 4, 2002
(86) PCT No.: PCT/JP02/12693

(30) Foreign Application Priority Data
Dec. 4, 2001 (JP) 2001-370542
May 21, 2002 (JP) 2002-146872
Oct. 29, 2002 (JP) 2002-314194

(51) Int. Cl. F16H 61/00

(52) U.S. Cl. 474/12

(57) ABSTRACT

To provide a continuously variable transmission and a control method thereof, allowing for control of the axial position of a movable sheave without a sensor for measuring the axial position of the movable sheave on a rotational shaft and for stable control with the movable sheave being held in position, without the increase in the size of mechanisms and power consumption.

A continuously variable transmission in which, on a rotational shaft 1 thereof are mounted a fixed sheave 2 positioned in the axial direction and a movable sheave 3 slidable axially, so as to face each other, a motor is provided for driving the movable sheave, and a slide driving means 16 is provided for sliding the movable sheave 3 axially by the rotation of the motor, characterized in that: the motor is a step motor 6, and the step motor 6 and the slide drive means 16 are mounted coaxially with the rotational shaft 1.

### TECHNICAL FIELD

This invention relates to a belt-type continuously variable transmission (CVT) installed in, for example, an engine for an automobile and a motorcycle, for transmitting the driving force from the engine to a driven axle and also relates to a control method thereof.

### BACKGROUND ART

In a continuously variable transmission for a vehicle or the like, a pair of sheaves (that is, a primary sheave on the driving side and a secondary sheave on the driven side) are mounted on a rotational shaft on the driving side and the driven side, respectively and an endless V-belt is bridged between both sheaves to couple both sheaves. Of the two sheaves, one is a fixed sheave that is axially positioned and the other is a movable sheave that can slide axially, both which are in turn mounted to the rotational shaft so as to face each other. Since the two opposite faces of a pair of the fixed and movable sheaves are tapered (in a conical shape), the radial distance of the endless belt from the center thereof changes corresponding to the distance between the fixed and movable sheaves and then, in response to that change, the rotational transmission ratio (variable speed ratio) changes in a stepless mode.

As one of conventional axial driving mechanisms for driving the movable sheave in CVTs, there has been used a constitution utilizing centrifugal force of weights, in which the movable sheave is axially moved in response to the expansion of the weights through a guide plate having a tapered face.

In such a constitution utilizing the centrifugal force of the weights as described above, it is difficult to obtain uniform centrifugal force and to regulate finely, resulting in inaccurate variable speed control.

Also, there has been known another continuously variable transmission having a movable sheave moved with the driving force from an electric motor rather than either of the centrifugal or hydraulic force (Refer to, for example, the Patent Document #1). In the CVT disclosed in this Patent Document, the rotational force is transmitted through a transmission gearing to a propulsion plate that is then driven to slide axially, thereby to move the movable sheave.

However, the CVT disclosed in the Patent Document #1 is provided with a motor outside of the sheave and also provided with transmission gears between the output shaft of the motor and the propulsion plate mounted on the rotational shaft. Accordingly, it is required to secure spaces near the rotational shaft for installation of the motor and transmission gears, resulting in a larger size of the whole system.

In order to control the rotational transmission ration it is also required to provide a sensor for measuring the axial position of the sliding movable sheave. As a result, a space for the sensor is also required, and the number of parts and the cost will be increased.

On the other hand, the applicant has already proposed, in a prior application, a control mechanism having a compact size for a continuously variable transmission in which the movable sheave (movable disc) can be driven (Refer to the Patent Document #2).

The control mechanism of a continuously variable transmission according to the proposal of the applicant is one in which, on a rotational shaft thereof are mounted a fixed disc positioned in axial direction and a movable disc slidable axially, a motor is provided for driving said movable disc, and a slide driving means is provided for sliding said movable disc axially, characterized in that and the step motor and the slide drive means are mounted coaxially with the rotational shaft.

According to this constitution, a compact constitution having a reduced space around the outside of the rotational shaft is obtained, because the motor and the slide driving means are not disposed in the space around the outside of the rotational shaft but mounted coaxially with the rotational shaft.

Notwithstanding such an improved control mechanism of the continuously variable transmission described in the prior application of the applicant, a sensor for measuring the position of the movable disc on the rotational shaft is still required.

When the continuously variable transmission is operated, a thrust force acts on the movable sheave due to the variation of torque. In order to always hold the movable sheave at a predetermined position against the thrust force, it is necessary to provide a complicated speed reduction mechanism, such as a planetary gear mechanism between the movable sheave and the motor shaft, or to always energize the motor for generating torque against the thrust force, resulting in a larger size of the mechanisms and the increase of consumption power.

It is also contemplated that an operation member as the slide drive means is mounted coaxially with a cylindrical motor to slide the movable sheave. In this case, it is also contemplated that, for example, the operation member having a cylindrical outer surface in spline coupling with the rotor of the motor and having a cylindrical inner surface in screw connection with the housing of the transmission is forced to move along a screw shaft relative to the housing with the rotation of the motor (Refer to, for example, the Patent Document #3).

Such a transmission described above has however possibilities to cause the accuracy of parts or components and reliability to be insufficient due to its complicated structure and more difficult machining thereof because the operation member has the inner and outer slide surfaces formed with female screws and splines, respectively. Furthermore, since the sliding resistance between the slide surfaces is increased, the load applied to the motor increases and thus the power consumption also increases. Accordingly, a larger motor of high output will be required.

Additionally, due to the spline-coupling between the rotor and the operation member, the movable sheave affected by the variation in the torque and offset load is apt to liberate.

Further, it is extremely difficult to tap precisely the housing of aluminum casting or die casting to form screw threads therein for engagement with the operation member, resulting in the reduction of accuracy and reliability for the control of variable speed ratio.

Additionally, since the screw threads on the operation member side are internal ones, it is impossible to increase the rotational radius. Accordingly, in order to obtain an axial torque required, the motor capacity must be increased, causing the power consumption and the motor size to be increased.

The operation member rotates and axially slides on the rotational shaft. If it slides to the terminal end and abuts the wall of the housing or the like, then it could screw in the wall with its self-tapping action, then bite therein and could not retract due to locking action.

Furthermore, on the engine output shaft, since the axial slide range of the movable flange does not overlap any axial slide range of the operation member pressing the movable flange, in other word, both the axial slide ranges are completely different, the length of both slide ranges in the axial direction is needed. As a result, it is not possible to obtain a compact configuration because of a larger structure. Within a limited space, the length of a guide member in the sliding portion of the movable flange is necessarily short. Therefore, the movable flange affected by the variation in the torque and offset load through a belt is apt to liberate further.

[Patent Document #1]

Publication of JP-Hei7-86383B

[Patent Document #2]

Publication of JP-2001-349401A

[Patent Document #3]

Publication of JP-Hei3-163248A

In consideration of such problems, it is an object of the invention to provide a continuously variable transmission and a control method thereof, allowing for control of the axial position of a movable sheave without a sensor for measuring the axial position of the movable sheave on a rotational shaft and for stable control with the movable sheave being held in position, without the increase in the size of mechanisms and power consumption.

It is a further object of the invention to provide a continuously variable transmission that is compact for space saving, easily manufactured, and consumes reduced power and can control the variable speed ratio high precisely and reliably.

### DISCLOSURE OF INVENTION

To achieve the above object, the present invention provides a continuously variable transmission in which, on a rotational shaft thereof are mounted a fixed sheave positioned in the axial direction and a movable sheave slidable axially, so as to face each other, a motor is provided for driving the movable sheave, and a slide driving means is provided for sliding the movable sheave axially by the rotation of the motor, characterized in that: the motor is a step motor, and the step motor and the slide drive means are mounted coaxially with the rotational shaft.

According to this configuration, mounting the step motor coaxially with the movable sheave of the primary sheave, for example, for directly slide-driving the movable sheave in the axial direction allows to simplify the components and to provide the compact structure, and the position of the movable sheave can be pulse-controlled according to the reference position by determining the reference position from electric current change of the step motor and also controlled with a high degree of accuracy by a simple structure without using the position detecting sensor in the axial direction. Furthermore, the movable sheave can certainly be maintained at the fixed position by position holding force of the step motor without large power consumption.

The preferred configuration example is characterized in that a predetermined reduction ratio is held with a slight electric power, or without electrification.

According to the above configuration, since the rotational angle of the rotor in the motor is held without electrification or with a slight electric power (1/10 or less of motor rating, for example) by stopping position holding force of the step motor, the reduction ratio at the position is maintained with little power consumption.

The preferred configuration example is characterized in that the control origin constituting a stopper for prohibiting the movable sheave or the slide drive means from moving further is set at the maximum spaced position of the movable sheave from the fixed sheave.

According to the above configuration, the abutting part on the movable sheave side forms the stopper structure abutting against the stopper receiving part on the casing side for example, and the stopper receiving part is determined as the control origin. This allows the step motor to be driven and controlled with reference to the control origin.

Furthermore, space saving is accomplished by disposing the step motor and the slide driving means coaxially with the rotational shaft.

In other words, as the characteristic of the step motor, the rotor is stopped and held in a fixed position. The turning angle of the rotor is controlled with a high degree of angular accuracy according to the input pulse. By controlling the sliding position of the sheave on the rotational shaft with such the characteristic of the step motor to determine the home position at first, the subsequent sliding amount of sheave can be strictly controlled with the number of steps of motor.

Conventionally, a position detecting sensor such as a potentiometer for detecting the actual absolute position of the sheave has been necessary when the sheave position is controlled. However, it was difficult to dispose the position detecting sensor in a limited space such as the inside of the crankcase.

The present invention can control the sliding amount of sheave by using a step motor to determine the control origin without an absolute position detecting sensor of the sheave.

The present invention provides, as a method of controlling the continuously variable transmission using the step motor, a method comprising the steps of: energizing the step motor to move the movable sheave away from the fixed sheave; stopping the electrification to the step motor at the time the movable sheave reaches the control origin; and hereafter, controlling to drive the step motor, using as the reference position the position of the step motor at the stoppage.

According to the above configuration, when a power source is turned on for operating the variable speed control, the movable sheave is moved at first to the direction away from the fixed sheave and abutted against the stopper structure to be stopped, the control origin is detected from electric current change with the stop, and the position of the movable sheave can be controlled with reference to the control origin.

In this case, the motor current is always measured with a controller such as ECU in an automobile engine and the like, so that sensors for detecting the home position are not required separately due to the detection of the electric current change.

In this case, the pushing force of the motor is maintained for a while after the stopper is abutted when a similar mechanical stopper is disposed with a servomotor other than the step motor, so that mechanical load in thread parts and the like becomes large; however, excessive pushing force is not generated after the abutting by stepping out the current in the step motor.

The present invention also provides a continuously variable transmission in which, on a rotational shaft thereof are mounted a fixed sheave positioned in the axial direction and a movable sheave slidable axially, so as to face each other, a motor is provided for driving the movable sheave, and a slide driving means is provided for sliding the movable sheave axially by the rotation of the motor, characterized in that: the motor has a rotor and a rotor cylinder integral with the rotor, the rotor being coaxial with the rotational shaft and located on the outer circumference thereof for rotation with respect to the rotational shaft; the slide drive means is a movable member having a portion in screw connection with the rotor cylinder; and the movable member is coaxial with the rotational shaft and located on the circumference thereof.

According to the above configuration, the motor and the slide driving means are coaxial with the rotational shaft to be variable-speed-controlled and located on the outer circumference thereof, so that the length in the axial direction can be shortened, and compact constitution can be provided. The slide driving means is directly connected with the rotor cylinder through the threads, so that the power transmission can be performed without transmission gear mechanisms, and the mechanism such as a spline coupling that may cause the extra sliding loss when the rotational force is applied from the motor is not provided so that feed frictional resistance in the axial direction becomes extremely small, and a motor loading can be reduced.

The preferred configuration example is characterized in that the slide driving means has an anti-rotating means for preventing the rotation with respect to the casing of the motor.

According to the above configuration, the slide driving means slides to the axial direction without rotatably moving in the axial direction or without rotating about the shaft. Therefore, when the electricity abnormality is generated, the motor additionally rotates to excess, and the slide driving means is abutted against the housing wall, the member that the slide driving means rotates may be screwed into the wall by a self tapping effect to produce the locking effect and incapable of returning; however, the present invention has the construction that the slide driving means does not rotate, so that even if it abuts against the wall by the motor malfunction, it will not be screwed into the wall and locked but returned easily, and the smooth movement is maintained.

The preferred configuration example is characterized in that the anti-rotating means has a portion in slide relation with the casing of the motor, the portion of the anti-rotating member having a different shape so as to prevent the rotation with respect to the casing of the motor.

According to the above configuration, the anti-rotating means is formed in a different shape of a triangle, rectangle, or other polygonal shape other than a circle for the cross-section of a cylindrical movable member, and a hole is correspondingly formed with the shape corresponding to the cover of the motor housing fixed to the crankcase, so that the rotation is prevented by sliding the movable member through the hole. If the cross section is a circle, the rotation can be prevented by inserting a key or a wedge in the gap with the motor housing.

The further preferred configuration example is characterized in that on the outer circumference of the slide drive means are formed external or male screw threads in screw connection with the rotor cylinder.

According to the above configuration, the screw threads for transmitting power from the motor side to the slide driving means are formed on the outer circumference of the slide drive means, so that the rotating radius can be set to produce large axial torque. The axial torque necessary to move and maintain the movable sheave is in proportion to r×f (r: rotating radius, f: force generated by the motor). The axial torque is uniquely determined by the design, so that f can be decreased when r is increased. When r decreases, the motor can be driven with less electric power, so that the size of the motor or power consumption can be reduced.

When a high output engine is connected to the input shaft, normally, the rotational speed of the motor is increased for generating big axial torque in order to increase the pushing force of the movable sheave. In this case, the screw thread pitch has to be small in order to properly adjust the feed rate; however, there is a limit in the minimum machining screw pitch for the accuracy of the screw thread cutting. The present invention adopts the external screw threads, so that the screw thread cutting can be processed easily, and the external screw threads with small screw thread pitch can be formed with ensuring the necessary accuracy.

The further preferred configuration example is characterized in that the movable sheave is mounted adjacent to the motor on the rotational shaft; and the movable sheave has fins in the back thereof, on the motor side.

According to the above configuration, the movable sheave rotated with the rotational shaft driven by the engine output has fins in the back side, so that the engine power is used as it is to send wind to the engine side with the fins of the movable sheave, and the engine can be cooled efficiently.

The further preferred configuration example is characterized in that the slide drive means is coupled through a bearing to the movable sheave so as to rotate with respect thereto and move axially therewith.

According to the above configuration, the bearing couples both the movable sheave and the slide drive means, so that the movable sheave and the slide drive means are substantially, integrally constructed through the bearing, and the movement in the axial direction is performed back and forth (to the directions that a space between a pair of sheaves expands and narrows) together. The positioning of the movable sheave is thereby controlled with a high degree of accuracy and reliably maintained at the position of a necessary variable speed ratio.

The movable member (the slider 16 in the embodiments, or the member that is movable in the axial direction) is screwed into the rotor cylinder 9 at one end in the axial direction as described later, and the other end of the member is integrally formed with the movable sheave 3 through the bearing 17, so that runouts of the slider 16 can be minimized.

The present invention also provides a continuously variable transmission in which, on a rotational shaft thereof are mounted a fixed sheave positioned in the axial direction and a movable sheave slidable axially, so as to face each other, a motor is provided for driving the movable sheave, and a slide driving means is provided for sliding the movable sheave axially by the rotation of the motor, characterized in that: the slide drive means has an overlapping area where the sliding area on the sliding member side on which the movable sheave slides corresponds to the whole or part of the sliding area on the slid member side on which a movable member slides; the movable means has a screw threaded section in screw connection with the slid member and has an anti-rotating member so as to prevent the rotation of the movable member with respect to the casing of the motor; and the screw threaded section and the anti-rotating member are provided on one of the external and the internal faces of the movable member.

According to the above configuration, the sliding area on the slide member side when the movable sheave slides on the sliding member (the collar 18 in the embodiments or the member fixed in the axial direction) is overlapped with the sliding area on the slid member side (the axial direction stationary member side) when the movable member slides on the slid member (the rotor cylinder 9 in the embodiments or the member fixed in the axial direction), so that the long sliding length of the movable sheave can be achieved in the limited space without increasing the total sliding length. Therefore, the variable speed ratio can be larger.

In addition, the member corresponding to the sliding member may be particular about the collar 18, all the member that the movable sheave slides correspond to the sliding member.

In this configuration, the thread part engaging with the slid member (rotor cylinder) is provided to the outer or inner periphery of the movable member (slider), and the anti-rotating means with the deformed cross section is disposed in plane therewith. The structure of the slider is thereby simplified, and the machining for the slider can be made easily at low cost. Furthermore, tasks such as repairs and replacements of the motor and a maintenance work for checking the V-belt can be simplified.

The preferred configuration example is characterized in that the anti-rotating means has a portion in slide relation with the casing of the motor, the portion of the anti-rotating member having a different shape so as to prevent the rotation with respect to the casing of the motor.

According to the above configuration, the cross section of the cylindrical slide driving means has a deformed shape other than a circle such as a triangle, a rectangle, or other polygon, and correspondingly, a hole having the shape corresponding to the cover of the motor housing fixed to crankcase is formed, so that the rotation is prevented by sliding the slide driving means through the hole. If the cross section is a circle, the rotation can be prevented by inserting a key or a wedge in the gap with the motor housing.

The present invention also provides a continuously variable transmission in which, on a rotational shaft thereof are mounted a fixed sheave positioned in the axial direction and a movable sheave slidable axially, so as to face each other, a motor is provided for driving the movable sheave, and a slide driving means is provided for sliding the movable sheave axially by the rotation of the motor, characterized in that the slide drive means has an overlapping area where the sliding area on the sliding member side on which the movable sheave slides corresponds to the whole or part of the sliding area on the slid member side on which a movable member slides; the movable means has a screw threaded section in screw connection with the slid member and has an anti-rotating member so as to prevent the rotation of the movable member with respect to the casing of the motor; and the screw threaded section is provided in an area axially different from that where the anti-rotating member is provided.

According to the above configuration, the sliding area on the slide member side when the movable sheave slides on the sliding member (the axial direction stationary member) is overlapped with the sliding area on the slid member side (the axial direction stationary member side) when the movable member slides on the slid member (the axial direction stationary member), so that the long sliding length of the movable sheave can be achieved in the limited space without increasing the total sliding length. Therefore, the variable speed ratio can be larger.

In this configuration, the movable member (slider) has the thread part engaging with the slid member (rotor cylinder), and the anti-rotating means having the deformed cross section for the motor casing is provided in the area different from the thread part in the axial direction. Therefore, the space in the axial direction is used, or in other words, the anti-rotating of the movable member is placed in the area adjacent to the motor, so that the structure simplifies, and tasks such as repairs and replacements of the motor and a maintenance work for checking the V-belt can be simplified.

The further preferred configuration example is characterized in that the main part of the motor is entirely or partially disposed in the overlapping area.

According to the above configuration, since the main part of the motor is entirely or partially disposed in the overlapping area, the space is saved, and the compact configuration can be obtained. Here, the main part of the motor means the main components of the stator and the rotor.

The present invention further provides a continuously variable transmission in which, on a rotational shaft thereof are mounted a fixed sheave positioned in the axial direction and a movable sheave slidable axially, so as to face each other, a motor is provided for driving the movable sheave, and a slide driving means is provided for sliding the movable sheave axially by the rotation of the motor, characterized in that: the motor is located so as to be coaxial with the rotational shaft or on the outer circumference of the rotational shaft, and positioned within the plane of axial projection of the outside diameter of the movable sheave.

According to the above configuration, since the motor is positioned within the plane of axial projection of the outside diameter of the movable sheave, the compact configuration can be obtained even if the motor is located so as to be coaxial with the rotational shaft or on the outer circumference of the rotational shaft. In this case, by combining with the described configuration that the motor is disposed in the overlapping area with the movable sheave, the motor can be made compact in the axial direction as well as in the radial direction of the sheave, and the layout space can be reduced more. The motor herein comprises a rotor rotating around the engine output shaft (rotational shaft) with respect to the rotational shaft, a stator facing to the rotor and disposed in the outer periphery thereof, and a rotor cylinder rotating with the rotor and disposed in the inner periphery thereof.

The present invention further provides a continuously variable transmission in which, on a rotational shaft thereof are mounted a fixed sheave positioned in the axial direction and a movable sheave slidable axially, so as to face each other, a motor is provided for driving the movable sheave, and a slide driving means is provided for sliding the movable sheave axially by the rotation of the motor, characterized in that: the slide drive means has an overlapping area where the sliding area on the sliding member side on which the movable sheave slides corresponds to the whole or part of the sliding area on the slid member side on which a movable member slides; and the main part of the motor is disposed in the overlapping area.

According to the above configuration, the sliding area on the slide member side when the movable sheave slides on the sliding member (the axial direction stationary member) is overlapped with the sliding area on the slid member side (the axial direction stationary member side) when the movable member slides on the slid member (the axial direction stationary member), so that the long sliding length of the movable sheave can be achieved in the limited space without increasing the total sliding length. Therefore, the variable speed ratio can be larger.

According to the above configuration, since the main part of the motor is entirely or partially disposed in the overlapping area, the space is saved, and the compact configuration can be obtained. The main part of the motor herein means the main components of the stator and the rotor.

The present invention also provides a continuously variable transmission in which, on a rotational shaft thereof are mounted a fixed sheave positioned in the axial direction and a movable sheave slidable axially, so as to face each other, a motor is provided for driving the movable sheave, and a slide driving means is provided for sliding the movable sheave axially by the rotation of the motor, characterized in that: the slide drive means has an overlapping area where the sliding area on the sliding member side on which the movable sheave slides corresponds to the whole or part of the sliding area on the slid member side on which a movable member slides; and the motor is located coaxially with and on the extension of the rotational shaft or located on the outer circumference of the rotational shaft, and positioned within the plane of axial projection of the outside diameter of the movable sheave.

According to the above configuration, the sliding area on the slide member side when the movable sheave slides on the sliding member (the axial direction stationary member) is overlapped with the sliding area on the slid member side (the axial direction stationary member side) when the movable member slides on the slid member (the axial direction stationary member), so that the long sliding length of the movable sheave can be achieved in the limited space without increasing the total sliding length. Therefore, the variable speed ratio can be larger.

According to the above configuration, since the motor is positioned within the plane of axial projection of the outside diameter of the movable sheave, the compact configuration can be obtained even if the motor is located so as to be coaxial with the rotational shaft or on the outer circumference of the rotational shaft. In this case, by combining with the described configuration that the motor is disposed in the overlapping area with the movable sheave, the motor can be made compact in the axial direction as well as in the radial direction of the sheave, and the layout space can be reduced more. The motor herein comprises a rotor rotating around the engine output shaft (rotational shaft) with respect to the rotational shaft, a stator facing to the rotor and disposed in the outer periphery thereof, and a rotor cylinder rotating with the rotor and disposed in the inner periphery thereof.

The present invention also provides a continuously variable transmission in which, on a rotational shaft thereof are mounted a fixed sheave positioned in the axial direction and a movable sheave slidable axially, so as to face each other, a motor is provided for driving the movable sheave, and a slide driving means is provided for sliding the movable sheave axially by the rotation of the motor, characterized in that: the slide drive means has an overlapping area where the sliding area on the sliding member side on which the movable sheave slides corresponds to the whole or part of the sliding area on the slid member side on which a movable member slides; the main part of the motor is disposed in the overlapping area; and the motor is located coaxially with and on the extension of the rotational shaft or located on the outer circumference of the rotational shaft, and positioned within the plane of axial projection of the outside diameter of the movable sheave.

According to the above configuration, the sliding area on the slide member side when the movable sheave slides on the sliding member (the axial direction stationary member) is overlapped with the sliding area on the slid member side (the axial direction stationary member side) when the movable member slides on the slid member (the axial direction stationary member), so that the long sliding length of the movable sheave can be achieved in the limited space without increasing the total sliding length. Therefore, the variable speed ratio can be larger.

According to the above configuration, since the main part of the motor is entirely or partially disposed in the overlapping area, the space is saved, and the compact configuration can be obtained. The main part of the motor herein means the main components of the stator and the rotor.

In addition, according to the above configuration, since the motor is positioned within the plane of axial projection of the outside diameter of the movable sheave, the compact configuration can be obtained even if the motor is located so as to be coaxial with the rotational shaft or on the outer circumference of the rotational shaft.

In a preferred example for application of the present invention, a continuously variable transmission having an overlapping area described above is applied to a motorcycle.

If this transmission is applied to a motorcycle, there exists an overlapping area where the slide range of the slide drive means coupled to the motor and the slide range of the movable sheave axially moved by the slide drive means overlaps each other, thereby to reduce the axial length of the transmission. Accordingly, if the transmission is located so that the axis of the transmission is placed in parallel with the width direction of the motorcycle, then the width of the engine section can be reduced. Therefore, the angle of inclination of the motorcycle body can be increased to the limit at which the motorcycle body does not interfere the road surface when the motorcycle is turned. This compact configuration allows the layout design to be versatile and maneuverability to be improved.

The present invention provides a continuously variable transmission comprising: a rotational shaft; a fixed sheave axially positioned on a rotational shaft; a movable sheave facing to said fixed sheave and slidable axially on the rotational shaft; a motor for driving said movable sheave; and a movable member for sliding the movable sheave, using said motor; wherein said movable sheave has a back face of a convex facing the fixed sheave side in axial direction; and wherein an axial overlapping area is provided at the position where the distance between said movable sheave and said motor is maximum.

According to the above configuration, further space saving is allowed because the motor and the movable sheave overlap each other, at least, at the maximum spaced position.

The present invention provides a continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of the motor, characterized in that: said motor is a step motor; and the control origin constituting a stopper for prohibiting said movable sheave or said slide drive means from moving further is set at the maximum spaced position of said movable sheave from said fixed sheave.

According to the above configuration, a stopper having a receiving section, for example on the casing side is formed, so that the abutting section on the movable sheave abuts the receiving section at the maximum spaced position of the movable sheave from the fixed sheave. The receiving section of the stopper is defined as the control origin for controlling the step motor to drive.

The present invention provides a method of controlling a continuously variable transmission, comprising: a turning on step of turning on the power source of an automatic variable speed controller; an initial setting step of performing a variety of initial settings through said power source turned on by the processing at the turning on step; a measuring step of driving a step motor from the condition initially set by the processing at the initial setting step, to move a movable member, and always measuring with said controller the driving current supplied to said step motor during the movement of said movable member; a detecting step of detecting the change in the current when said movable member driven by said step motor strikes a control origin to be stopped to move, the drive current of said step motor being measured by the processing at the measuring step; a stopping step of stopping the supply of drive current to said step motor for stopping the movement of said movable sheave when the change in the current is detected by the processing at the detecting step; an origin setting step of setting as said control origin the position of said step motor where said movable sheave is stopped by the processing at the stopping step; and a control step of controlling the rotational angle of a rotor with inputting the input required on the basis of said control origin as the reference that is set by the processing at the origin setting step, for controlling the position of said movable sheave though said moving member.

According to the above configuration, when the power source of the controller is turned on, the initial setting is performed and then the step motor is driven to cause the movable member to abut the control origin. The change of current at the time of this abutment is read and defined as the control origin for the step motor. The rotational angle of the rotor is controlled on the basis of the control origin for performing the positioning control of the movable sheave.

Thus, the positioning control of the movable sheave can be performed accurately by controlling the number of steps of the step motor, without detection of actual position of the movable sheave.

The initial setting herein includes processes and routines, such as initialization of the internal memories and parameters of the controller, setting of the I/O ports, timer or the like, checking on LEDs on the display section, determination of abnormality for the opening position of an accelerator.

The present invention provides a continuously variable transmission comprising: a turning-on means for turning on the power source of an automatic variable speed controller; an initial setting means for performing a variety of initial settings through said power source turned on by the turning-on means; a measuring means for driving a step motor from the condition initially set by the initial setting means, to move a movable member, and always measuring with said controller the driving current supplied to said step motor during the movement of said movable member; a detecting means for detecting the change in the current when said movable member driven by said step motor strikes a control origin to be stopped to move, the drive current of said step motor being measured by the measuring means; a stopping means for stopping the supply of drive current to said step motor for stopping the movement of said movable sheave when the change in the current is detected by the detecting means; an origin setting means for setting as said control origin the position of said step motor where said movable sheave is stopped by the stopping means; and a control means for controlling the rotational angle of a rotor with inputting the input required on the basis of said control origin as the reference that is set by the origin setting means, for controlling the position of said movable sheave though said moving member.

According to the above configuration, a method of controlling the continuously variable transmission, according to the present invention, including the turning on step, the initial setting step, the measuring step, the detecting step, the stopping step, the origin setting step and the controlling step is adequately implemented. Accordingly, the positioning control of the movable sheave can be performed accurately by controlling the number of steps of the step motor, without detection of actual position of the movable sheave.

The present invention provides a continuously variable transmission comprising: a rotational shaft; a fixed sheave axially positioned on a rotational shaft; a movable sheave facing to said fixed sheave and slidable axially on the rotational shaft; a motor for driving said movable sheave; and a movable member for axially sliding the movable sheave with the driving force of said motor; wherein said motor includes a stator and a rotator, said stator drives said rotator and said rotator converts the electromagnetic force generated therebetween into a rotational force; and wherein said movable member engages said rotator in screw connection or pin fitting.

According to the above configuration, since the movable member is coupled with the rotator through screws or pins, the driving force can be transmitted without any gearing mechanisms. Also, since no mechanism, such as a spline coupling mechanism, possibly producing any loss in sliding action is provided, the friction resistance in axial feed becomes extremely low to reduce the load applied to the motor. In this constitution the rotator is composed of a rotor and a rotor cylinder.

The present invention provides a continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of the motor, characterized in that: wherein said motor includes a stator, a rotor and a rotor cylinder integral with said rotor, said stator drives said rotor and said rotor converts the electromagnetic force generated therebetween into a rotational force; wherein said slide driving means is a movable member having an area that engages said rotor cylinder each other; and wherein said rotor cylinder and said movable member engages in screw connection or pin fitting.

According to the above configuration, since the slide drive means is coupled with the rotor cylinder integral with the rotor through screws or pins, the driving force can be transmitted without any gearing mechanisms. Also, since no mechanism, such as a spline coupling mechanism, possibly producing any loss in sliding action is provided, the friction resistance in axial feed becomes extremely low to reduce the load applied to the motor. In this constitution the rotator is composed of a rotor and a rotor cylinder.

By manufacturing each of the components separately, each component can be processed or machine easily, resulting in cost reduction.

The present invention provides a continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of the motor, characterized in that: wherein said motor includes a stator, a rotor and a rotor cylinder integral with said rotor, said stator drives said rotor and said rotor converts the electromagnetic force generated therebetween into a rotational force; and wherein said slide driving means is a movable member having an area that engages said rotor cylinder each other; wherein said rotor cylinder and said movable member engages in ball-screw connection.

According to the above configuration, since the slide drive means is coupled with the rotor cylinder integral with the rotor, the sliding resistance is further reduced. As a result, a desired variable ratio is obtained with lower output of the motor.

The present invention provides a continuously variable transmission comprising: a rotational shaft; a fixed sheave axially positioned on a rotational shaft; a movable sheave facing to said fixed sheave and slidable axially on the rotational shaft; a motor for driving said movable sheave; and a movable member for axially sliding the movable sheave with the driving force of said motor; wherein said motor includes a stator and a rotator, said stator drives said rotator and said rotator converts the electromagnetic force generated therebetween into a rotational force; and wherein said movable member engages said rotator each other; and wherein said movable sheave is axially slid with the rotation of said motor, without any rotation of said movable sheave.

According to the above configuration, although the rotator as a rotational mechanical element engages the movable member, the latter slides without rotation.

If the slide member abuts the wall or the like, it does not screw in the wall to be locked therein. And it retracts easily and maintains its smooth.

The present invention further provides a continuously variable transmission comprising: a rotational shaft; a fixed sheave axially positioned on a rotational shaft; a movable sheave facing to said fixed sheave and slidable axially on the rotational shaft; a motor for driving said movable sheave; and a movable member for axially sliding the movable sheave with the driving force of said motor; wherein said motor includes a stator and a rotor, said stator drives said rotor and said rotor converts the electromagnetic force generated therebetween into a rotational force; and wherein, in one of said movable member and said rotor is formed a helical groove, while in the other is formed a projection for engagement with said helical groove.

According to the above configuration, since the motor and the movable member engages directly each other in projection-groove connection (for example, screw connection or pin fitting), the driving force can be transmitted without any gearing mechanism and therefore the loss in sliding action can be reduced.

In a preferred example for application of the present invention, the continuously variable transmission having an overlapping area described above, or the continuously variable transmission having the control origin, or the continuously variable transmission in which the movable member and the rotator engages in screw connection, pin fitting or ball screw connection, or the continuously variable transmission in which the movable sheave is axially slid with the rotation of the motor, without any rotation of said movable sheave is applied to a motorcycle.

If the continuously variable transmission is applied to motorcycles, as has been described, there exists an overlapping area where the slide range of the slide drive means coupled to the motor and the slide range of the movable sheave axially moved by the slide drive means overlaps each other, thereby to reduce the axial length of the transmission. Accordingly, if the transmission is located so that the axis of the transmission is placed in parallel with the width direction of the motorcycle, then the width of the engine section can be reduced. Therefore, the angle of inclination of the motorcycle body can be increased to the limit at which the motorcycle body does not interfere the road surface when the motorcycle is turned. This compact configuration allows the layout design to be versatile and maneuverability to be improved.

### BRIEF DESCRIPTION OF DRAWINGS

FIG. 1 shows a constitution of the continuously variable transmission related to the embodiment of the invention.

FIG. 2 shows a constitution of the continuously variable transmission of FIG. 1, explaining the action thereof.

FIG. 3 is a flow chart for the control method of the continuously variable transmission of FIG. 1.

FIG. 4 shows a shape example of an anti-rotating means of the slider.

FIG. 5 shows an explanatory diagram of the constitution illustrating an example of a pin-fit construction between the rotor cylinder and the slider.

### BEST MODE FOR CARRYING OUT THE INVENTION

Embodiments of the invention will be described below with reference to the accompanying drawings.

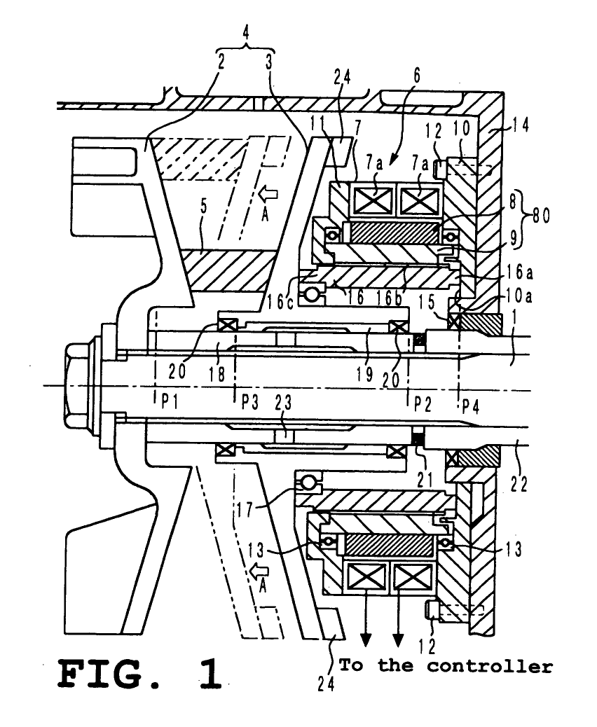

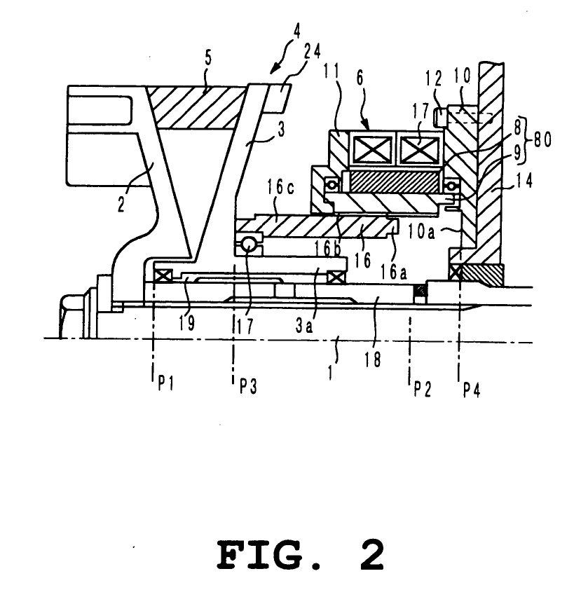

FIG. 1 shows a constitution of a portion of a CVT related to an embodiment of the invention. FIG. 2 shows a constitution of a portion of the continuously variable transmission of FIG. 1, explaining its action.

On an engine output shaft 1 is mounted a primary sheave (drive side sheave) 4 consisting of a pair of opposed fixed sheave 2 and movable sheave 3. The fixed sheave 2 and the movable sheave 3 are formed in a conical shape at their opposed surfaces. Between these opposed conical surfaces is mounted a V-belt 5. A driven shaft (not shown) connected to an axle, for example, is provided in parallel with the engine output shaft 1, and this driven shaft is also provided with a secondary sheave (driven side sheave) consisting of a pair of fixed sheave and movable sheave. The V-belt 5 is wound over the primary sheave 4 and the secondary sheave (not shown), and variable speed ratio is continuously varied according to the space between the fixed sheave 2 and the movable sheave 3. The V-belt 5 transmits the rotation of the sheaves from the engine output shaft 1 to the driven shaft (not shown).

A step motor 6 is mounted on the rear side of the movable sheave 3 and on the engine output shaft 1 coaxial with the movable sheave 3. The step motor 6 comprises a stator 7 including coils 7a, and a rotator 80 including magnets (ferrite magnets, for example), and the rotator 80 comprises a rotor 8, and a rotor cylinder 9 integral with the rotor 8. This rotor cylinder 9 serves as a slider receiver which receives a slider, as described later. The coils 7a are connected to a control circuit (CPU) within a controller (ECU) (not shown) to drive-control the step motor 6 according to operating states. The step motor 6 is mounted in a casing 10 and covered with a cover 11. The rotor 8 along with the rotor cylinder 9, is rotatable via bearings 13 with respect to the casing 10 and cover 11, and the stator 7 fixed thereto. The casing 10 is secured to a crankcase 14 with a plurality of bolts 12. The engine output shaft 1 is inserted into the crankcase 14 through an oil seal 15.

A slider 16 is screwed on the inner side of the rotor cylinder 9 of the rotor 8 and axially slidably mounted on the engine output shaft 1. The slider 16 is formed with an external screw, and this external screw and an internal thread formed in the rotor cylinder 9 are screwed together, and the slider 16 axially slides without being rotated by the rotation of the rotor 8, as described later. This slider 16 is rotatable via a bearing 17 with respect to the movable sheave 3. At this time when the slider 16 moves the movable sheave, a slid member (the rotor cylinder 9) on the surface of which the slider 16 slides, rotates about its axis but does not axially move. That is, the rotor cylinder 9 is an axially fixed rotating member.

This bearing 17 is coupled to both the slider 16 and movable sheave 3, and connects both so that they are rotatable with respect to each other and axially move integrally. That is, the movable sheave 3 and the slider 16 constitute an integral member via the bearing 17.

On the engine output shaft 1 is mounted a collar 18 to integrally rotate through serration coupling or the like. On the collar 18 is mounted a bushing 19 integrally coupled to the movable sheave 3 to rotate integrally with the collar 18 and engine output shaft 1. The bushing 19 along with the movable sheave 3, is axially movable along the collar 18. Oil seals 20 are provided at both ends of the bushing 19.

The collar 18 and the bushing 19 are arranged such that either of them is provided with pins (not shown), for example, and the other is provided with axial slots into which these pins are axially slidably fitted, and they are fixedly connected to each other in their rotational direction via the pins and the slots. By this, the movable sheave 3, the bushing 19 and the collar 18 integrally rotate synchronously with the rotation of the engine output shaft 1.

The collar 18 which serves as a sliding guide member for the movable sheave 3, is in contact with the root portion of the fixed sheave 2 at its front end (left end of the drawing), and an output shaft sleeve 22 which rotates integrally with the engine output shaft 1, via a ring member 21, at its rear end. Therefore, the collar 18 rotates with the engine output shaft 1 in the state of being securedly held in the axial direction of the engine output shaft 1. Onto the output shaft sleeve 22 is fixed a drive chain sprocket (not shown). The reference numeral 23 designates an oil hole.

The movable sheave 3, at a sliding cylinder part 3a of its root portion, axially slides along the collar 18 via the bushing 19 integrally fixed to the inner side thereof. The sliding cylinder part 3a of this movable sheave 3 axially slides along the collar 18 within the range between the farthermost position from the fixed sheave 2 in FIG. 1 and the nearest position thereto in FIG. 2. That is, the axial sliding area for a sliding portion (the sliding cylinder part 3a) of the movable sheave 3 is within the range between the maximum advanced position P1 (FIG. 2) at its front end and the maximum retracted position P2 (FIG. 1) at its rear end.

In terms of the collar 18 (an axially fixed member) which axially guides the movable sheave 3, this range corresponds to a portion of the collar 18 (referred to as a sliding member in Claim 11) which causes the movable sheave to slide (a slid portion).

As thus described, in respect of the sliding movement of the movable sheave 3, the sliding area for a sliding movable member (the movable sheave 3 itself) is within the range between P1 and P2, and accordingly, the sliding area (slid portion) is formed in the axially fixed sliding member corresponding to the collar 18.

In this case, the moving range of the slider 16 (axially movable member) integral with the movable sheave 3 is between a front end position P3 of the slider 16 when it is fully advanced shown in FIG. 2, and a rear end position P4 thereof when it is fully retracted shown in FIG. 1.

In terms of the rotor cylinder 9 (an axially fixed member) which allows the screwed slider 16 to axially move, this range corresponds to an internally threaded portion, which causes the slider 16 to slide, of the rotating member, that is, the axially fixed rotor cylinder 9 (referred to as a slid member in Claim 11) which allows the slider 16 (referred to as a movable member in Claim 11) to axially move.

As thus described, in respect of the sliding movement of the slider 16 which slidingly drives the movable sheave 3, the sliding area for a movable member (the slider 16 itself) is within the range between P3 and P4, and the sliding area (a slid area) in the axially fixed member (rotor cylinder 9) corresponding thereto is the internally threaded portion of the rotor cylinder 9.

In respect of the forgoing sliding movement of the movable sheave, comparisons will be made in the sliding range between the movable members (the movable sheave 3 and the slider 16) and between the stationary members (the collar 18 and the rotor cylinder 9), respectively. In terms of the sliding movable members, the sliding area for the movable sheave 3 (the range between P1 and P2) axially overlaps that for the slider 16 (the range between P3 and P4). Further, in terms of the stationary members, the range of the slid portion in the collar 18 axially overlaps that of the length of the internal thread in the rotor cylinder 9.

In this way, in respect of the axial sliding area for the movable sheave 3 and the slider 16, the sliding movable members have the area overlapping each other in part (or in entirety), and the axially immovable stationary members have the area overlapping each other in part (or in entirety). Therefore, the axial length can be reduced in a more compact manner.

In this overlapping area (the area between P2 and P3 or the area between the front end of the rotor cylinder 9 and the rear end of the collar 18) is located a main part of the step motor 6 (its axial length in part or in entirety). Thus, a more compact layout is obtained.

In this embodiment, the internal thread is formed in the rotor cylinder 9, and an external screw 16b is formed in the slider 16 to be fitted therein. This external screw 16b, as shown in FIG. 2, is formed in a portion, which is fitted in the internal thread in the rotor cylinder 9, of the slider 16, when the slider 16 is fully advanced. The slider 16 has a shape other than a circular shape in section on the side forwardly of the foregoing portion, which serves as an anti-rotating part 16c.

As thus described, since the slider 16 is only externally screwed into the rotor cylinder 9, the movable sheave can slidingly be driven without cutting threads and splines on both the inner and outer sliding surfaces of the member which slidingly drives the movable sheave. Therefore, the constitution is simplified as well as cutting work and accuracy in parts is increased, so that reliability in drive control can be improved. Further, since sliding resistance becomes lower, motor loading is reduced and power consumption is reduced, so that a low-powered, small-sized motor can be employed.

Further, since the bearing 17 mutually rotatably connects the movable sheave 3 and a slide driving means (the slider 16), the movable sheave 3 and the slider 16 are substantially made integral via the bearing 17, so that their axial reciprocating movement is integrally performed (in the advanced and retracted direction of the movable sheave 3). Therefore, the positioning control of the movable sheave is performed with high accuracy, and the movable sheave can reliably be held at a position producing necessary variable speed ratio.

Further, since the slide driving means (slider 16) is screwed into the rotor cylinder 9 on its rear end side and integral with the movable sheave 3 via the bearing 17 on its front end side, the slider 16 is prevented from swinging.

Furthermore, the slider does not rotate but axially slides. Therefore, even if it slides to the terminal end of the rotor cylinder 9 and comes into contact with the wall of a housing or the like, since it is free from a self tapping effect, no problem occurs such as the slider screwing and cutting into the wall to produce a locking effect, so that it cannot return to its original position.

Incidentally, the foregoing embodiment is arranged such that the rotor cylinder 9 and the slider 16 are mutually screwed together with the external screw 16b formed in the slider 16 and the internal thread in the rotor cylinder 9 fitted in each other. However, ball screws may be employed for this screw thread structure. By employing the ball screws, frictional resistance is further reduced, and when the rotation of the rotor cylinder 9 is converted into the sliding movement and transmitted to the slider 16, the frictional resistance extremely becomes low. Therefore, the low-power, smooth positioning movement of the movable sheave is achieved, so that the motor is reduced in size and power saving is effected.

Further, in place of the foregoing screwing, the rotor cylinder 9 and the slider 16 may be connected to each other through pin-fitting. This pin-fitting is arranged such that a spiral groove is formed in either the rotor cylinder 9 or the slider 16, and a pin (protrusion) inserted into and slidable along this groove is formed in the other, and the rotation of the rotor cylinder 9 causes the slider 16 to linearly move via the pin and the groove.

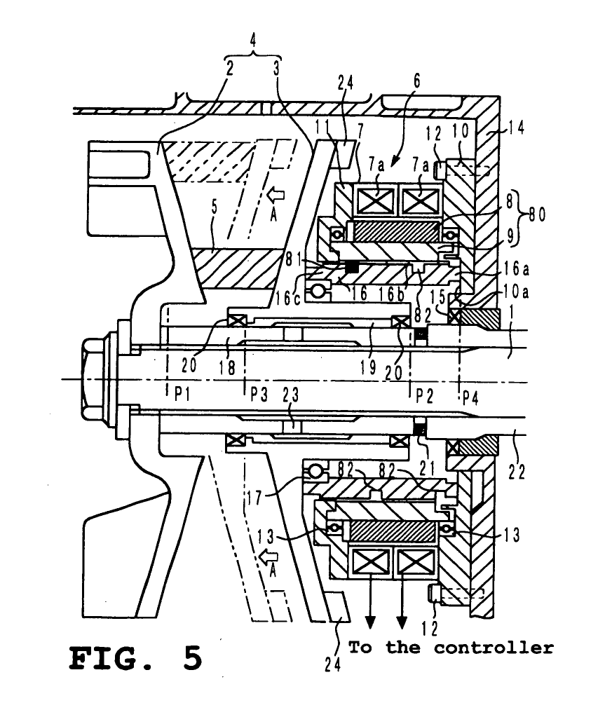

FIG. 5 shows an example of such pin-fitting. As illustrated, a pin 81 is provided on the inner side of the rotor cylinder 9 on its front end side (the side closer to the bearing 17). A spiral groove 82 into which this pin 81 is inserted is formed on the outer perimeter surface of the slider 16. This groove 82 is formed to extend to the end of the slider 16 on the inner side of the rotor cylinder 9 on its rear end side (the side closer to the casing 10). Since the slider 16 is provided with an anti-rotating means, when the rotor cylinder 9 rotates, the slider 16 linearly moves via the pin 81 inserted into the groove 82. Thus, the slider 16 is allowed to slide by the rotation of the rotor cylinder 9. Other constitutions, and functions and effects are the same as with the foregoing embodiment.

Incidentally, as a means for allowing the slider 16 to linearly move by the rotation of the rotor cylinder 9, the screwing and pin-fitting have been exemplified, but the embodiment is not limited thereto. Any means is acceptable if it is arranged such that either the rotor cylinder 9 or the slider 16 is formed with a spiral recess and the other a protrusion corresponding thereto, and the slider 16 is allowed to slide in mutual engagement with the rotor cylinder 9. In this case, the protrusion may be provided, in part or in entirety, in the moving range of the slider on the rotor cylinder or the slider. It may be pin-like as in the foregoing embodiment, or a protrusion with a certain length.

The step motor 6 is disposed in an axial projection surface of the outside diameter of the movable sheave 3 when viewed from the axial direction of the engine output shaft 1. Thus, a more compact constitution is obtained.

Fins 24 are formed on the rear side of the movable sheave 3. These fins 24 are capable of efficiently sending cooling air against the step motor 6.

When the step motor 6 is rotatively driven in the forward (or reverse) direction, the movable sheave 3, while rotating with the engine output shaft 1, is advanced (or retracted) via the slider 16 from its illustrated maximum spaced position from the fixed sheave 2 (position for the maximum reduction ratio) to its variable speed position on full speed side shown by double dot and dash lines, as shown by arrows A.

FIG. 2 shows the state of the movable sheave 3 being fully advanced by the slider 16.

The rotation of the rotor cylinder 9 in the step motor 6 causes the screwed coaxial slider 16 to be pushed out to move the movable sheave 3 closer to the fixed sheave 2. Thus, the V-belt 5 is pushed up to its largest diameter position.

The movable sheave 3 always receives a thrust in its retracted direction from the drive wheel (secondary sheave) via the V-belt 5, according to the torque fluctuations of the drive wheel. When the slider 16 is retracted by the step motor 6 rotatively being driven in the reverse direction, the movable sheave 3 is also retracted.

In this case, as described above, the movable sheave 3 and the slider 16 are made integral and axially slide integrally. Therefore, the position control of the slider 16 causes the movable sheave 3 to reliably slide to be position-controlled.

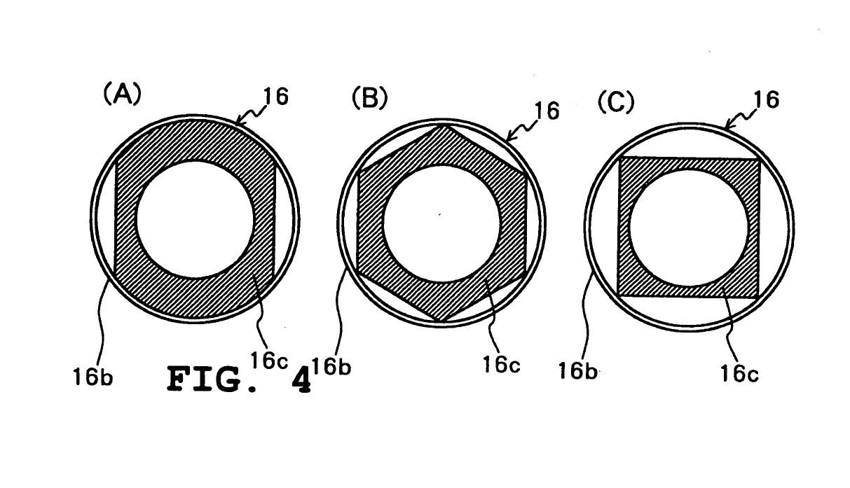

The slider 16 is not allowed to rotate so as to prevent the slider 16 from cutting into the casing 10 to produce the locking effect. Therefore, the anti-rotating part 16c of the slider 16 has a shape other than a circular shape in section. A portion, which is inserted into the cover 11 for the casing 10 of the step motor 6, of the slider 16 (the anti-rotating part 16c) has a cross-section of a spanner-engaging, parallel-sided circular shape, as shown in FIG. 4(A), or of a hexagonal or square shape, as shown in FIGS. 4(B) and (C), respectively, or of other polygonal shapes. Accordingly, a through-hole in the fixed cover 11 is formed in the same shape as that of the slider 16. Thus, the slider 16 does not rotate about its axis but axially slides. Further, it can be prevented from rotating by providing a key or a wedge between the slider 16 and the cover 11. That is, if the anti-rotating part 16c and the corresponding through-hole in the cover 11 have a circular shape with respect to each other, since there is no protrusion or corner which prevents the slider 16 from rotation, the slider 16 is allowed to freely rotate. However, since they are formed in a shape other than the circular shape or provided with the key or the wedge therebetween, the slider 16 is prevented from rotation.

This anti-rotating part 16c may be smaller in outside diameter than the external screw part 16b, and, accordingly, the through-hole in the cover 11 may be smaller.

From the rear end of the slider 16 (right side of FIG. 1 and FIG. 2) is projected an abutting part 16a which serves as a stopper. This abutting part 16a abuts against a stopper receiving part 10a of the casing 10 to allow the slider 16 to stop its retracting sliding movement. This stopper receiving part 10a with which the abutting part 16a comes into contact, serves as a control origin, a reference position for the positioning control of the movable sheave 3 described later.

The step motor 6 for use herein can be of known PM type, VR type or HB type. It is rotated by a certain angle (step) for every change in the energized state of the coils through an inputted pulse signal. If no change is found in the energized state, the step motor 6 is held still at a certain position.

By controlling the sliding position of the sheave on the rotational shaft with such characteristics of the step motor to determine the home position at first, the subsequent sliding amount of sheave can be strictly controlled with the number of steps of motor.

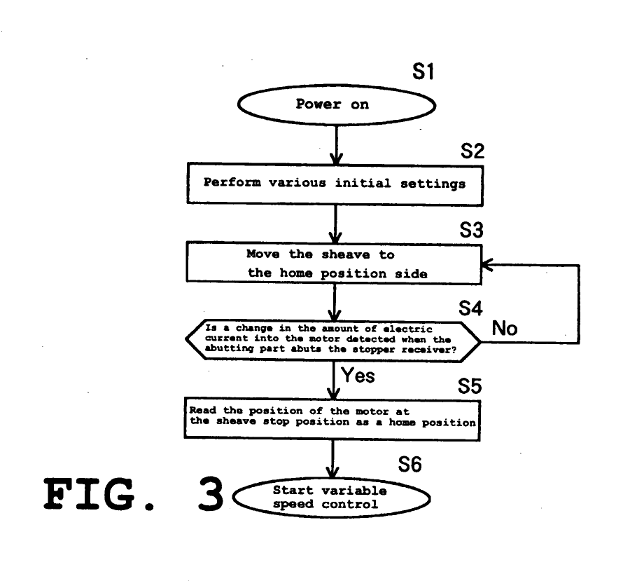

FIG. 3 is a flow chart for the control method of the continuously variable transmission related to the present invention. Movements in each step are as follows.

Step S1: The power source for the controller of an automatic variable speed control (e.g., ECU for an automobile engine) turns on, and the automatic variable speed control is started.

Step S2: Various initial settings are made. For example, initialization of controller internal memory or variables, setting of I/O ports or timers, LED check of an indicating section, abnormality determination of accelerator opening positions are performed.

Step S3: The step motor 6 is driven to move the slider 16 backward (move to the direction of the casing 10) and to slide the movable sheave 3 to the direction away from the fixed sheave 2 (control origin side). At that time, the driving current to the step motor 6 is measured all the time in the controller during the movement.

Step S4: The presence of electric current changes at the time when the abutting part 16a of the slider 16 abuts against the stopper receiving 10a of the casing 10 and stops the movement is determined. If there is no electric current change, the backward movement is continued. If the slider abuts against the home position (stopper receiving 10a) and the electric current change is detected, then the step goes to the following S5.

Step S5: The driving current to the step motor is cut, and the movable sheave 3 is stopped. The position of the step motor 6 at the stopping position is set as the control origin.

Step S6: With reference to the control origin that has been set, the rotating angle of the rotor is controlled by the necessary pulse input, and the position of the movable sheave 3 is controlled through the slider 16. Thereby, the position of the movable sheave from the home position is controlled with a high degree of accuracy according to the corresponding steps to the number of pulse. In this case, in order to obtain the predetermined variable speed ratio depending on the operational status, it is preferable that a number-of-rotation sensor is provided to each of the primary sheave and the secondary sheave to detect rotation speed, and feedback control is performed so as to obtain the appropriate variable speed ratio all the time.

The movable sheave of the primary sheave receives thrust in the direction pushed back to the direction to the home position from torque fluctuations of the drive wheel during the driving while performing the speed control. It is necessary to produce the torque opposing to the thrust so that the sheave position does not vary if the thrust is received. To accomplish the above, the conventional structure needed to be provided with the complicated reduction mechanism such as a planetary mechanism between the movable sheave and the motor output shaft or to produce large torque by always energizing the motor. The present invention uses a step motor, so that, by using the step position holding force, it is unnecessary to complicate the mechanism or energize the motor all the time (or it only needs little electric power to the extent of 1/10 or less of the motor rating), and electric power in use can be reduced as much as possible.

As described above, when the primary sheave is maintained in a fixed position during the driving and the reduction ratio is maintained at constant, there are cases of constant speed driving after accelerating from a standstill and a manual operation in variable speed mode. The manual operation in variable speed mode is adapted in the continuously variable speed mechanism to electronically control the sheave position and set any two or more target variable speed values from the maximum value to the minimum values of the variable speed range in advance. Hand operation buttons for shifting up/down are disposed near a hand of the operator, and the operator can arbitrarily change the preset variable speed ratio during the driving by operating the buttons. On this account, the continuously variable transmission can be operated as a manual shift type transmission.

The primary sheave in the present invention can be maintained at the fixed position by position holding force of the step motor in the above case.

The present invention is not limited to the present embodiment described above, and the position of the stopper structure may be set in a minimum spaced position between the movable sheave and the fixed sheave as the engaging rotation end of the rotor and the slider or at any position. Particularly, because the force applied for the sheave movement is not necessary when the stopper structure is set in the minimum spaced position, the slider can be moved even if the engine stops.

The best embodiment is the present embodiment provided with the control origin where the movable sheave 3 or the slide driving means abuts against the maximum spaced position that the movable sheave 3 moves away from the fixed sheave 2 and thereby the stopper structure is constructed.

### Industrial Applicability

As described above, the present invention provides the step motor mounted coaxially with the movable sheave of the primary sheave, for example, for directly slide-driving the movable sheave in the axial direction and thereby allows to simplify the components and to provide the compact structure, and the position of the movable sheave can be pulse-controlled according to the reference position by determining the reference position from electric current change of the step motor and also controlled with a high degree of accuracy by a simple structure without using the position detecting sensor in the axial direction. Furthermore, the movable sheave can certainly be maintained at the fixed position by position holding force of the step motor without large power consumption.

The motor and the slide driving means are coaxial with the rotational shaft to be variable-speed-controlled and located on the outer circumference thereof, so that the length in the axial direction can be shortened, and compact constitution can be provided. Also, the slide driving means is directly connected with the rotor cylinder through the threads, so that the power transmission can be performed without transmission gear mechanisms, the space is saved, and feed frictional resistance in the axial direction is extremely smaller than the spline coupling when the rotational force is applied from the motor, so that a motor loading can be reduced.

According to the configuration that the slide driving means has an anti-rotating means with respect to the casing of the motor, the slide driving means slides to the axial direction without rotating about the shaft. Therefore, when the electricity abnormality is generated, the motor excessively rotates, and the slide driving means is abutted against the housing wall, the slide driving means will not be screwed into the wall and locked but returned easily, and the smooth movement is maintained.

When the configuration is made such that the screw threads for transmitting power from the motor side to the slide driving means are formed on the outer circumference of the slide drive means, the rotating radius can be set to large to produce large axial torque, so that the size of the motor or power consumption can be reduced. The present invention adopts the external screw threads, so that the screw thread cutting can be processed easily, and the external screw threads with small screw thread pitch can be formed with ensuring the necessary accuracy.

The movable sheave rotated with the rotational shaft driven by the engine output has fins in the back side, so that the engine power is used as it is to send wind to the engine side with the fins of the movable sheave, and the engine can be cooled efficiently.

According to the configuration that the slide drive means is coupled through a bearing to the movable sheave so as to rotate with respect thereto and move axially therewith, the bearing couples both the movable sheave and the slide drive means, so that the movable sheave and the slide drive means are substantially, integrally constructed through the bearing, and the movement in the axial direction is performed back and forth together. The positioning of the movable sheave is thereby controlled with a high degree of accuracy and reliably maintained at the position of a necessary variable speed ratio.

According to the configuration that the sliding area where the slide drive means moves along the rotor cylinder to the axial direction in the condition that the slide drive means is held in the rotor cylinder is overlapped with the sliding area where the part engaging with the slide guide member moves to the axial direction when the movable sheave slides along the slide guide member disposed on the rotational shaft to the axial direction in the condition that the sheave is mounted on the rotational shaft, the long sliding length of the movable sheave can be achieved in the limited space without increasing the total sliding length. Therefore, the variable speed ratio can be larger.

When the sliding section is overlapped in the limited space, the guiding part of the sliding section of the movable sheave can be made long. The driving and driven sheaves receive power from the belt always subject to the torque fluctuations and rotate with receiving the offset load, so that the fluttering of the movable sheave can be effectively prevented by extending the guiding part of the sliding section of the movable sheave as described above.

According to the configuration that the main part of the motor is entirely or partially disposed in the overlapping area, since the main part of the motor is entirely or partially disposed in the overlapping area, the space is saved, and the compact configuration can be obtained.

According to the configuration that the motor is positioned within the plane of axial projection of the outside diameter of the movable sheave, since the motor is positioned within the plane of axial projection of the outside diameter of the movable sheave, the compact configuration can be obtained. When it is combined with the described configuration that the motor is disposed in the overlapping area with the movable sheave, the configuration is simplified more, and the layout space can be reduced more.

If this transmission is applied to a motorcycle, there exists an overlapping area where the slide range of the slide drive means coupled to the motor and the slide range of the movable sheave axially moved by the slide drive means overlaps each other, thereby to reduce the axial length of the transmission. Accordingly, if the transmission is located so that the axis of the transmission is placed in parallel with the width direction of the motorcycle, then the width of the engine section can be reduced. Therefore, the angle of inclination of the motorcycle body can be increased to the limit at which the motorcycle body does not interfere the road surface when the motorcycle is turned. This compact configuration allows the layout design to be versatile and maneuverability to be improved.

1-29. (canceled).

30: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
said motor is a step motor, and said step motor and said slide drive means are mounted coaxially with said rotational shaft.

31: The continuously variable transmission according to claim 30, wherein a predetermined reduction ratio is held with a slight electric power, or without electrification.

32: The continuously variable transmission according to claim 30, wherein the control origin constituting a stopper for prohibiting said movable sheave or said slide drive means from moving further is set at the maximum spaced position of said movable sheave from said fixed sheave.

33: A method of controlling the continuously variable transmission of claim 32, comprising the steps of:
energizing said step motor to move said movable sheave away from the fixed sheave;
stopping the electrification to said step motor at the time said movable sheave reaches said control origin; and
hereafter, controlling to drive said step motor, using as the reference position the position of said step motor at the stoppage.

34: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
said motor has a rotor and a rotor cylinder integral with said rotor, said rotor being coaxial with said rotational shaft and located on the outer circumference thereof for rotation with respect to said rotational shaft;
said slide drive means is a movable member having a portion in screw connection with said rotor cylinder; and
said movable member is coaxial with said rotational shaft and located on the circumference thereof.

35: The continuously variable transmission according to claim 34, wherein said slide driving means has an anti-rotating means for preventing the rotation with respect to the casing of said motor.

36: The continuously variable transmission according to claim 35, wherein said anti-rotating means has a portion in slide relation with the casing of said motor, said portion of said anti-rotating member having a different shape so as to prevent the rotation with respect to the casing of said motor.

37: The continuously variable transmission according to claim 34, wherein on the outer circumference of said slide drive means are formed external or male screw threads in screw connection with said rotor cylinder.

38: The continuously variable transmission according claim 34, wherein said movable sheave is mounted adjacent to the motor on said rotational shaft; and the movable sheave has fins in the back thereof, on the motor side.

39: The continuously variable transmission according to claim 34, wherein said slide drive means is coupled through a bearing to said movable sheave so as to rotate with respect thereto and move axially therewith.

40: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
said slide drive means has an overlapping area where the sliding area on the sliding member side on which said movable sheave slides corresponds to the whole or part of the sliding area on the slid member side on which a movable member slides;
said movable means has a screw threaded section in screw connection with said slid member and has an anti-rotating member so as to prevent the rotation of the movable member with respect to the casing of said motor; and
said screw threaded section and said anti-rotating member are provided on one of the external and the internal faces of said movable member.

41: The continuously variable transmission according to claim 40, wherein said anti-rotating means has a portion in slide relation with the casing of said motor, said portion of said anti-rotating member having a different shape so as to prevent the rotation with respect to the casing of said motor.

42: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that
said slide drive means has an overlapping area where the sliding area on the sliding member side on which said movable sheave slides corresponds to the whole or part of the sliding area on the slid member side on which a movable member slides;
said movable means has a screw threaded section in screw connection with said slid member and has an anti-rotating member so as to prevent the rotation of the movable member with respect to the casing of said motor; and
said screw threaded section is provided in an area axially different from that where said anti-rotating member is provided.

43: The continuously variable transmission according to claim 40, wherein the main part of said motor is entirely or partially disposed in said overlapping area.

44: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
said motor is located so as to be coaxial with said rotational shaft or on the outer circumference of said rotational shaft, and positioned within the plane of axial projection of the outside diameter of said movable sheave.

45: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
said slide drive means has an overlapping area where the sliding area on the sliding member side on which said movable sheave slides corresponds to the whole or part of the sliding area on the slid member side on which a movable member slides; and
the main part of said motor is entirely or partially disposed in said overlapping area.

46: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
said slide drive means has an overlapping area where the sliding area on the sliding member side on which said movable sheave slides corresponds to the whole or part of the sliding area on the slid member side on which a movable member slides; and
said motor is located coaxially with and on the extension of said rotational shaft or located on the outer circumference of said rotational shaft, and positioned within the plane of axial projection of the outside diameter of said movable sheave.

47: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
said slide drive means has an overlapping area where the sliding area on the sliding member side on which said movable sheave slides corresponds to the whole or part of the sliding area on the slid member side on which a movable member slides;
the main part of said motor is entirely or partially disposed in said overlapping area; and
said motor is located coaxially with and on the extension of said rotational shaft or located on the outer circumference of said rotational shaft, and positioned within the plane of axial projection of the outside diameter of said movable sheave.

48: The motorcycle comprising the continuously variable transmission according to claim 40.

49: A continuously variable transmission comprising:
a rotational shaft;
a fixed sheave axially positioned on a rotational shaft;
a movable sheave facing to said fixed sheave and slidable axially on the rotational shaft;
a motor for driving said movable sheave; and
a movable member for sliding the movable sheave, using said motor;
wherein said movable sheave has a back face of a convex facing the fixed sheave side in axial direction; and
wherein an axial overlapping area is provided at the position where the distance between said movable sheave and said motor is maximum.

50: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
said motor is a step motor; and
the control origin constituting a stopper for prohibiting said movable sheave or said slide drive means from moving further is set at the maximum spaced position of said movable sheave from said fixed sheave.

51: A method of controlling a continuously variable transmission, comprising:
a turning on step of turning on the power source of an automatic variable speed controller;
an initial setting step of performing a variety of initial settings through said power source turned on by the processing at the turning on step;
a measuring step of driving a step motor from the condition initially set by the processing at the initial setting step, to move a movable member, and always measuring with said controller the driving current supplied to said step motor during the movement of said movable member;
a detecting step of detecting the change in the current when said movable member driven by said step motor strikes a control origin to be stopped to move, the drive current of said step motor being measured by the processing at the measuring step;
a stopping step of stopping the supply of drive current to said step motor for stopping the movement of said movable sheave when the change in the current is detected by the processing at the detecting step;
an origin setting step of setting as said control origin the position of said step motor where said movable sheave is stopped by the processing at the stopping step; and
a control step of controlling the rotational angle of a rotor with inputting the input required on the basis of said control origin as the reference that is set by the processing at the origin setting step, for controlling the position of said movable sheave though said moving member.

52: A continuously variable transmission comprising:
a turning-on means for turning on the power source of an automatic variable speed controller;
an initial setting means for performing a variety of initial settings through said power source turned on by the turning-on means;
a measuring means for driving a step motor from the condition initially set by the initial setting means, to move a movable member, and always measuring with said controller the driving current supplied to said step motor during the movement of said movable member;
a detecting means for detecting the change in the current when said movable member driven by said step motor strikes a control origin to be stopped to move, the drive current of said step motor being measured by the measuring means;
a stopping means for stopping the supply of drive current to said step motor for stopping the movement of said movable sheave when the change in the current is detected by the detecting means;
an origin setting means for setting as said control origin the position of said step motor where said movable sheave is stopped by the stopping means; and
a control means for controlling the rotational angle of a rotor with inputting the input required on the basis of said control origin as the reference that is set by the origin setting means, for controlling the position of said movable sheave though said moving member.

53: A continuously variable transmission comprising:
a rotational shaft;
a fixed sheave axially positioned on a rotational shaft;
a movable sheave facing to said fixed sheave and slidable axially on the rotational shaft;
a motor for driving said movable sheave; and
a movable member for axially sliding the movable sheave with the driving force of said motor;
wherein said motor includes a stator and a rotator, said stator drives said rotator and said rotor converts the electromagnetic force generated therebetween into a rotational force; and
wherein said movable member engages said rotator in screw connection or pin fitting.

54: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
wherein said motor includes a stator, a rotor and a rotor cylinder integral with said rotor, said stator drives said rotor and said rotor converts the electromagnetic force generated therebetween into a rotational force;
wherein said slide driving means is a movable member having an area that engages said rotor cylinder each other; and
wherein said rotor cylinder and said movable member engages in screw connection or pin fitting.

55: A continuously variable transmission in which, on a rotational shaft thereof are mounted a fixed sheave positioned in the axial direction and a movable sheave slidable axially, so as to face each other, a motor is provided for driving said movable sheave, and a slide driving means is provided for sliding said movable sheave axially by the rotation of said motor, characterized in that:
wherein said motor includes a stator, a rotor and a rotor cylinder integral with said rotor, said stator drives said rotor and said rotor converts the electromagnetic force generated therebetween into a rotational force; and
wherein said slide driving means is a movable member having an area that engages said rotor cylinder each other;
wherein said rotor cylinder and said movable member engages in ball-screw connection.

56: A continuously variable transmission comprising:
a rotational shaft;
a fixed sheave axially positioned on a rotational shaft;
a movable sheave facing to said fixed sheave and slidable axially on the rotational shaft;
a motor for driving said movable sheave; and
a movable member for axially sliding the movable sheave with the driving force of said motor;
wherein said motor includes a stator and a rotator, said stator drives said rotator and said rotator converts the electromagnetic force generated therebetween into a rotational force; and
wherein said movable member engages said rotator each other; and
wherein said movable sheave is axially slid with the rotation of said motor, without any rotation of said movable sheave.

57: A continuously variable transmission comprising:
a rotational shaft;
a fixed sheave axially positioned on a rotational shaft;
a movable sheave facing to said fixed sheave and slidable axially on the rotational shaft;
a motor for driving said movable sheave; and
a movable member for axially sliding the movable sheave with the driving force of said motor;
wherein said motor includes a stator and a rotator, said stator drives said rotator and said rotator converts the electromagnetic force generated therebetween into a rotational force; and
wherein, in one of said movable member and said rotator is formed a helical groove, while in the other is formed a projection for engagement with said helical groove.

58: The motorcycle comprising the continuously variable transmission according to claim 49.
